(19) United States
(12) Patent Application Publication
(10) Pub. No.: US 2026/0245272 A1
(43) Pub. Date: Aug. 20, 2026

(54) GENERATING SYNTHESIZED DIGITAL IMAGES UTILIZING A MULTI-TASK UNIVERSAL FRAMEWORK BASED ON IMAGE FRAMES

(71) Applicant: Adobe Inc., San Jose, CA (US)

(72) Inventors: Xi Chen, San Jose, CA (US); Zhifei Zhang, San Jose, CA (US); He Zhang, San Jose, CA (US); Yuqian Zhou, Seattle, WA (US); Soo Ye Kim, Daejeon (KR); Qing Liu, Santa Clara, CA (US); Yijun Li, Seattle, WA (US); Jianming Zhang, Campbell, CA (US); Nanxuan Zhao, San Jose, CA (US); Yilin Wang, San Jose, CA (US); Hui Ding, Cupertino, CA (US); Zhe Lin, Fremont, CA (US)

(21) Appl. No.: 19/053,803

(22) Filed: Feb. 14, 2025

(51) Int. Cl. G06T 11/60; G06F 40/284; G06F 40/40

(52) U.S. Cl. CPC G06T 11/60; G06F 40/284; G06F 40/40; G06T 2210/12

(57) ABSTRACT

The present disclosure relates to systems, non-transitory computer-readable media, and methods for generating a synthesized digital image based on reference digital images and a case prompt. In one or more embodiments, the disclosed systems determine one or more reference digital images and a case prompt including a natural language description of a target digital image in response to a request. The disclosed systems utilize an encoder neural network to generate image patch embeddings from the one or more reference digital images with one or more role indicators for the one or more reference digital images and noise patch embeddings from latent noise. The disclosed systems combine the image patch embeddings, the noise patch embeddings, and a case prompt encoding to form a composite embedding. The disclosed systems utilize a diffusion neural network to generate a synthesized digital image based on the composite embeddings and the one or more role indicators.

### BACKGROUND

A key challenge in generating digital images is the difficulty of creating an application that successfully generates digital images across different domains and for different tasks while maintaining visual consistency. Specifically, digital images that cover different types of scenery and objects have different properties that require significant expertise or specialized tools to perform various image editing tasks on the digital images. For example, image editing tasks that edit properties of shadows, reflections, lighting effects, people, non-person objects, etc., require different knowledge for the different domains, which causes creating realistic results very challenging. Although some existing software applications for generating and editing digital images have become progressively specialized in both tasks and methods, the existing systems exhibit a number of drawbacks or disadvantages in generating and editing digital images for a variety of different tasks.

### SUMMARY

This disclosure describes one or more embodiments of systems, methods, and non-transitory computer readable media that solve one or more of the foregoing or other problems in the art by generating and editing digital images via a single multi-task universal framework by unifying image-level tasks as discontinuous frame generation. Specifically, the disclosed systems characterize one or more reference digital images as pseudo frames for generating a synthesized digital image in connection with a text prompt. In one or more embodiments, the disclosed systems utilize an encoder neural network to generate image patch embeddings corresponding to the reference digital image(s), with the image patch embeddings including role indicators for the one or more reference digital images and/or indexes indicating an order of the reference digital image(s). In one or more embodiments, the disclose systems extract a text embedding from a text prompt (e.g., including a task prompt and/or a case prompt) and combining the image patch embeddings with the text patch embedding and noise patch embeddings to form a composite embedding. The disclosed systems utilize a diffusion neural network to generate a synthesized digital image based on the composite embedding.

### BRIEF DESCRIPTION OF THE DRAWINGS

The disclosure describes one or more embodiments of the invention with additional specificity and detail by referencing the accompanying figures. The following paragraphs briefly describe those figures.

FIG. 1 illustrates a diagram of an environment in which a multi-task image editing system operates in accordance with one or more embodiments.

FIG. 2 illustrates a diagram of an overview of the multi-task image editing system utilizing a multi-task universal framework to generate a synthesized digital image in accordance with one or more embodiments.

FIG. 3 illustrates a diagram of the multi-task image editing system generating an image data embedding from latent frames corresponding to reference digital images in accordance with one or more embodiments.

FIG. 4 illustrates a diagram of the multi-task image editing system generating a text embedding from a task prompt and a case prompt in accordance with one or more embodiments.

FIG. 5 illustrates a diagram of the multi-task image editing system generating a synthesized digital image from a composite embedding in accordance with one or more embodiments.

FIG. 6 illustrates a diagram of the multi-task image editing system generating a training dataset from sampled frames of a video in accordance with one or more embodiments.

FIG. 7 illustrates a diagram of the multi-task image editing system training a diffusion neural network in accordance with one or more embodiments.

FIGS. 8A-8B illustrate examples of the multi-task image editing system generating synthesized digital images from reference digital images and text prompts in accordance with one or more embodiments.

FIG. 9 illustrates an example schematic diagram of the multi-task image editing system in accordance with one or more embodiments.

FIG. 10 illustrates an example flowchart of a series of acts for generating a synthesized digital image utilizing a multi-task universal framework based on image frames in accordance with one or more embodiments.

FIG. 11 shows an example of a guided diffusion model according to aspects of the present disclosure.

FIG. 12 shows an example of a U-Net according to aspects of the present disclosure.

FIG. 13 shows an example of a method for conditional media generation according to aspects of the present disclosure.

FIG. 14 shows a diffusion process according to aspects of the present disclosure.

FIG. 15 shows a flow diagram depicting an algorithm as a step-by-step procedure for training a machine-learning model according to aspects of the present disclosure.

FIG. 16 shows an example of a method for training a diffusion model according to aspects of the present disclosure.

FIG. 17 shows an example of a computing device according to aspects of the present disclosure.

FIG. 18 shows an example of a synthesized image generation apparatus according to aspects of the present disclosure.

### DETAILED DESCRIPTION

This disclosure describes one or more embodiments of a multi-task image editing system that leverages a multi-task universal framework including encoder neural networks and a diffusion neural network to generate synthesized digital images from one or more reference digital images and a text prompt. For example, the multi-task image editing system uses one or more reference digital items and a text prompt (e.g., natural language instructions) to guide the generation of a synthesized digital image. In one or more embodiments, the synthesized image generation system utilizes the encoder neural networks to generate image patch embeddings for the reference digital image(s), including indications of roles for the reference digital image(s), a text embedding for the text prompt, and embeddings linking the reference digital image(s) to portions of the text prompt. The multi-task image editing system generates a composite embedding by combining the image patch embeddings, the text embedding, and noise patch embeddings to indicate a hierarchical prompt including task-level, image-level, and case-level indications. In one or more embodiments, the multi-task image editing system utilizes the diffusion neural network to generate a synthesized digital image from the composite embedding.

As mentioned, in one or more embodiments, the multi-task image editing system utilizes encoder neural networks to generate embeddings from digital images and text prompts. Specifically, the multi-task image editing system utilizes a first encoder neural network to generate image patch embeddings from one or more reference digital images representing various attributes to use as a guide for image synthesis. For example, the synthesized image generation system generates image patch embeddings from latent frames corresponding to the one or more reference digital images. In one or more embodiments, the multi-task image editing system also generates index embeddings indicating an order for the reference digital image(s). In one or more embodiments, the multi-task image editing system also generates embedding pairs associating the image patch embeddings with referential words from a case prompt. In one or more embodiments, the multi-task image editing system assigns roles for the image patch embeddings representing roles corresponding to the reference digital image(s).

In one or more embodiments, the multi-task image editing system utilizes a second encoder neural network to generate a text embedding representing a case prompt and/or a task prompt. In one or more embodiments, the multi-task image editing system encodes the case prompt, which includes a natural language description of a target synthesized digital image, and the task prompt, which includes one or more predefined tasks in connection with the case prompt. In one or more embodiments, the multi-task image editing system also links one or more referential words from the case prompt to the one or more reference digital images (e.g., via index embeddings).

In one or more embodiments, the multi-task image editing system combines the text embedding, the image patch embeddings, and noise patch embeddings-which represent latent noise for the diffusion neural network—to generate a composite embedding. In one or more embodiments, the synthesized image generation system utilizes a diffusion neural network to process the composite embedding and generate a synthesized digital image. In particular, the synthesized image generation system generates the synthesized digital image to include attributes guided by the reference digital image(s) and the text prompt (including the case prompt and/or the task prompt). Thus, the multi-task image editing system combines assets, backgrounds, and asset positions of the reference digital image(s) according to the case prompt and the text prompt to generate the synthesized digital image.

In one or more additional embodiments, the multi-task image editing system generates a training dataset to train parameters of the diffusion neural network based on sampled frames of digital videos. For example, the multi-task image editing system randomly samples a first frame and a second frame from one or more digital videos from a digital video dataset for various image editing tasks. Additionally, the synthesized image generation system generates and/or accesses captions including a natural language description of how to convert the first frame to the second frame. Alternatively, the multi-task image editing system generates captions describing one or more assets localized in the first and second frames. In additional embodiments, the multi-task image editing system generates masks for pairs of frames to include in the training dataset.

As suggested above, existing systems exhibit drawbacks or deficiencies in accurately and consistently generating synthesized digital images across various tasks. Although some conventional systems generate synthesized digital images from reference digital images, such systems have a number of problems or inadequacies in relation to accuracy, flexibility, and efficiency. For instance, conventional systems inaccurately generate synthesized digital images that fail to match a given text prompt or fail to accurately incorporate assets from reference digital images. To illustrate, some conventional systems generate synthesized digital images that depict the description of the given text prompt but either do not incorporate the assets of the reference digital images or distort the assets of the reference digital images. Further, some conventional systems generate synthesized digital images that incorporate the assets of the reference digital images but do not accurately match the given text prompt.

Additionally, conventional systems are inflexible. For instance, certain conventional systems are limited to generating synthesized digital images in certain fields or domains. Indeed, some existing systems are limited to certain output types for the synthesized digital image (e.g., visual try-on, face personalization, image stylization), certain reference digital image types, or are only capable of incorporating assets from a single reference digital image. These conventional systems are thus often highly specialized and unable to extend to different types of tasks or different domains.

Further, conventional systems are inefficient. For instance, certain conventional systems require training on different datasets to be able to generate synthesized digital images in a new domain or field. For example, these conventional systems require separate instances and/or architectures of neural networks trained on the different datasets to be able to perform image tasks in different domains. Additionally, these conventional systems also require operations to generate the different datasets for training in each new domain or field, which often use different types of digital images and sources, resulting in large amounts of computer processing and memory usage.

As suggested, embodiments of the synthesized image generation system provide several advantages and benefits over conventional systems. For example, the synthesized image generation system improves accuracy over prior systems. In contrast to conventional systems that inaccurately synthesize image content involving text and image prompts, the multi-task image editing system utilizes a universal framework that accurately performs multiple tasks by treating reference digital images as individual frames. By combining and correlating text embedding information with image embedding information for text prompts and reference digital images into a single embedding, the synthesized image generation system generates synthesized digital images incorporating image content from reference digital images while matching the text prompt. For example, unlike prior systems that do not incorporate or distort assets from the reference digital images, the multi-task image editing system utilizes embedding pairs with index embeddings and role indicators to indicate roles for the reference digital images to accurately integrate assets, backgrounds, or positions into synthesized digital images based on the reference digital images.

The multi-task image editing system also improves flexibility relative to conventional systems. Specifically, by generating training datasets that leverage frame pairs from digital video with captions as training data, the multi-task image editing system includes many types of image variations that are naturally covered between two discontinuous video frames. Further, by utilizing a variety of videos from video databases to construct the training set, the synthesized image generation system learns to generate synthesized digital images in a variety of domains or fields. Thus, the multi-task image editing system utilizes the multi-task universal framework to perform a plurality of tasks across multiple domains with a single neural network architecture.

The multi-task image editing system also improves efficiency relative to conventional systems. Specifically, in contrast to conventional systems that utilize different models to perform different tasks, the multi-task image editing system leverages a single neural network architecture to perform a plurality of separate tasks, thereby improving the efficiency of the synthesizing process. Additionally, the multi-task image editing system generates and utilizing a training dataset constructed from a variety of videos from video databases to train the multi-task universal framework in a variety of different domains or fields. Thus, the multi-task image editing system avoids the need for generating or accessing many different image datasets to train across domains/fields.

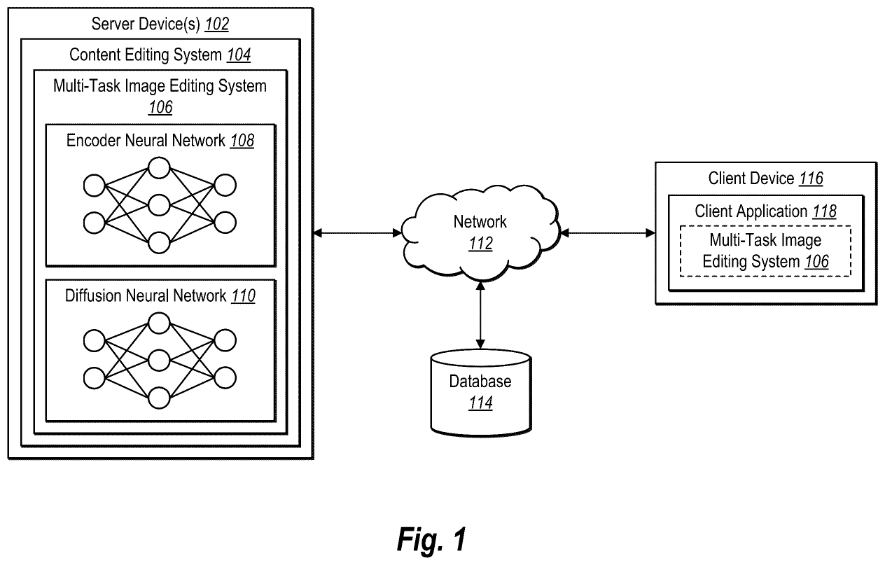

Additional detail regarding the multi-task image editing system 106 will now be provided with reference to the figures. For example, FIG. 1 illustrates a schematic diagram of an example system environment for implementing a multi-task image editing system 106 in accordance with one or more embodiments. An overview of the multi-task image editing system 106 is described in relation to FIG. 1. Thereafter, a more detailed description of the components and processes of the multi-task image editing system 106 is provided in relation to the subsequent figures.

As shown, the environment includes server device(s) 102, a database 114, a network 112, and a client device 116. Each of the components of the environment communicate via the network 112, and the network 112 is any suitable network over which computing devices communicate.

As mentioned, the environment includes a client device 116. The client device 116 is one of a variety of computing devices, including a smartphone, a tablet, a smart television, a desktop computer, a laptop computer, a virtual reality device, an augmented reality device, or another computing device. The client device 116 communicates with the server device(s) 102 via the network 112. For example, the client device 116 provides information to server device(s) 102 indicating client device interactions (e.g., selecting reference digital images, receiving a text prompt) and receives information from the server device(s) 102 (e.g., a synthesized digital image). Thus, in some cases, the multi-task image editing system 106 on the server device(s) 102 provides and receives information based on client device interaction via the client device 116.

As shown in FIG. 1, the client device 116 includes a client application 118. In particular, the client application 118 is a web application, a native application installed on the client device 116 (e.g., a mobile application, a desktop application, etc.), or a cloud-based application where all or part of the functionality is performed by the server device(s) 102. Based on instructions from the client application 118, the client device 116 presents or displays information to a user. For example, the client device 116 presents synthesized digital images according to reference digital images and a text prompt as generated by the multi-task image editing system 106 and interpreted by a processor (e.g., a graphics processor) and/or renderer on the client device 116. In some cases, the client device 116 includes a version of the multi-task image editing system 106.

As illustrated in FIG. 1, the environment includes the server device(s) 102. The server device(s) 102 generates, tracks, stores, processes, receives, and transmits electronic data, such as reference digital images, text prompts, training information, and synthesized digital images. The server device(s) 102, for example, receives data from the client device 116 in the form of an indication of a client device interaction (e.g., reference digital images or a text prompt) to generate a synthesized digital image from the client device interaction. In response, the server device(s) 102 transmits data to the client device 116 to display or present a synthesized digital image based on the client device interaction.

In some embodiments, the server device(s) 102 communicates with the client device 116 to transmits and/or receive data via the network 112 including client device interactions, digital images, text prompts, and/or other data. In some embodiments, the server device(s) 102 comprises a distributed server where the server device(s) 102 includes a number of server devices distributed across the network 112 and located in different physical locations. The server device(s) 102 comprise a content server, an application server, a communication server, a content editing server, a web-hosting server, a multidimensional server, and/or a machine learning server. The server device(s) further access and utilize the database 114 to store and retrieve information such as digital designs, target aspect ratios, and all or part of the encoder neural network 108 and the diffusion neural network 110.

In some cases, an encoder neural network refers to a neural network architecture designed to process input data to generate a compressed representation of it. In particular, an encoder neural network maps input data, such as images, text, or signals, to a lower-dimensional space to retain essential features while reducing the dimensionality of the data. For example, an encoder neural network processes the input through multiple layers of neurons performing operations such as weighted summation, activation functions, and dimensionality reduction to encode the data into a compact, fixed-length vector representation.

In some cases, a diffusion neural network refers to a neural network architecture designed to model diffusion of data over time. In particular, a diffusion neural network models gradual transformation of data from random noise to structured outputs by simulating its diffusion across a system. For example, a diffusion neural network iteratively applies learned transformations in tasks such as generative modeling (e.g., generating synthesized digital images) by iteratively noising and then reconstructing the data step by step.

Relatedly, in some embodiments, a neural network includes or refers to a machine learning model trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., synthesized digital images) based on a plurality of inputs provided to the neural network. In some cases, a neural network implements deep learning techniques to model high-level abstractions in data. A neural network includes various layers such as an input layer, one or more hidden layers, and an output layer that each perform tasks for processing data. For example, a neural network includes a deep neural network, a convolutional neural network, a recurrent neural network (e.g., an LSTM), a graph neural network, or a large language model.

As further shown in FIG. 1, the server device(s) 102 also includes the multi-task image editing system 106 as part of a content editing system 104. For example, in one or more implementations, the content editing system 104 is able to store, generate, modify, edit, enhance, provide, distribute, and/or share content such as digital images. For example, the content editing system 104 provides tools for the client device 116, via the client application 118, to generate synthesized digital images using the encoder neural network 108 and the diffusion neural network 110.

In one or more embodiments, the server device(s) 102 includes all, or a portion of, the multi-task image editing system 106. For example, the multi-task image editing system 106 operates on the server device(s) 102 to generate synthesized digital images. In some cases, the multi-task image editing system 106 utilizes, locally on the server device(s) 102 or from another network location (e.g., the database 114), the encoder neural network 108 and the diffusion neural network 110 to generate a synthesized digital design.

In certain cases, the client device 116 includes all or part of the multi-task image editing system 106. For example, the client device 116 generates, obtains (e.g., downloads), or utilizes one or more aspects of the multi-task image editing system 106 from the server device(s) 102. Indeed, in some implementations, as illustrated in FIG. 1, the multi-task image editing system 106 is located in whole or in part on the client device 116. For example, the multi-task image editing system 106 includes a web hosting application that allows the client device 116 to interact with the server device(s) 102. To illustrate, in one or more implementations, the client device 116 accesses a web page supported and/or hosted by the server device(s) 102.

In one or more embodiments, the client device 116 and the server device(s) 102 work together to implement the multi-task image editing system 106. For example, in some embodiments, the server device(s) 102 train the encoder neural network 108 and the diffusion neural network 110 and provide the encoder neural network 108 and the diffusion neural network 110 to the client device 116 for implementation. In some embodiments, the client device 116 attaches reference digital images and text prompts, the server device(s) 102 generates the synthesized digital image, and the client device 116 presents the synthesized digital image. Furthermore, in some implementations, the client device 116 assists in generating the synthesized digital image.

Although FIG. 1 illustrates a particular arrangement of the environment, in some embodiments, the environment has a different arrangement of components and/or may have a different number or set of components altogether. For instance, as mentioned, the multi-task image editing system 106 is implemented by (e.g., located entirely or in part on) the client device 116. In addition, in one or more embodiments, the client device 116 communicates directly with the multi-task image editing system 106, bypassing the network 112. Further, in some embodiments, the encoder neural network 108 and the diffusion neural network 110 include one or more components stored in the database 114, maintained by the server device(s) 102, the client device 116, or a third-party device.

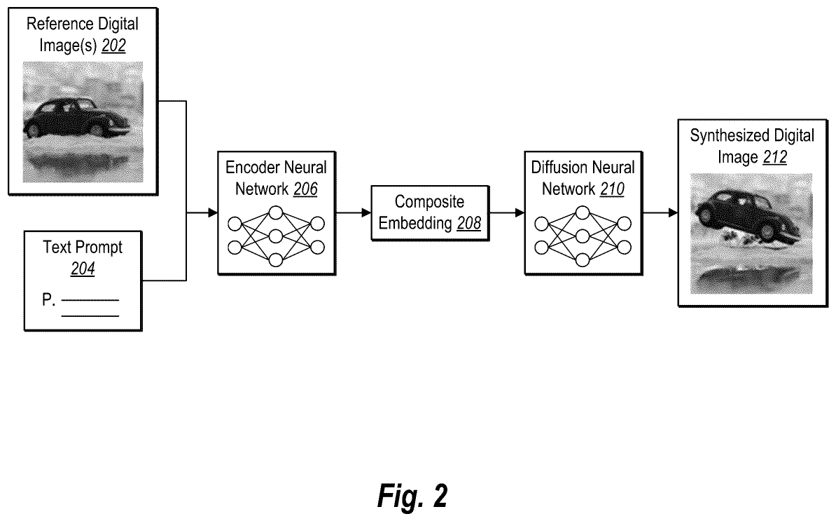

As mentioned, in one or more embodiments, the multi-task image editing system 106 generates a synthesized digital image according to a multi-task universal framework. FIG. 2 illustrates an overview of the multi-task image editing system 106 generating a synthesized digital image from reference digital image(s) and a text prompt utilizing an encoder neural network and a diffusion neural network in accordance with one or more embodiments. Additional detail regarding the various acts and processes mentioned with respect to FIG. 2 is provided thereafter with respect to subsequent figures.

As illustrated in FIG. 2, the multi-task image editing system 106 receives one or more reference digital image(s) 202 for guiding image synthesis. In particular, the multi-task image editing system 106 receives the reference digital image(s) 202 from a client device (e.g., the client device 116 of FIG. 1) in connection with a prompt (e.g., the text prompt 204) instructing the multi-task image editing system 106 to generate a synthesized digital image (e.g., the synthesized digital image 212) via an image generation pipeline. As described in more detail below, the multi-task image editing system 106 uses content of the reference digital image(s) 202 to guide image synthesis based on different types of reference material in the reference digital image(s) 202. For instance, the multi-task image editing system 106 utilizes assets (e.g., a toy car), backgrounds (e.g., a snowy background), and/or positioning (e.g., an object in the foreground of the image) from the reference digital image(s) 202 to guide generation of a synthesized digital image.

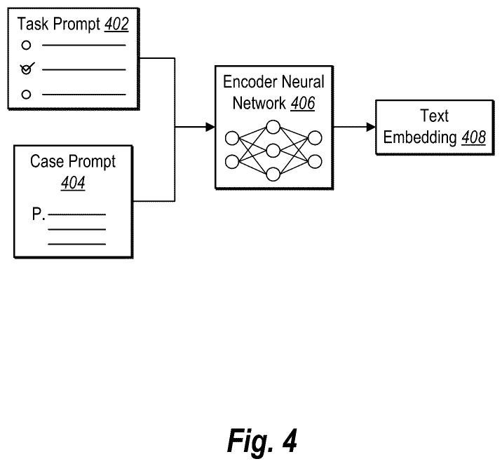

As further illustrated in FIG. 2, the multi-task image editing system 106 receives a text prompt 204 including instructions to generate a synthesized digital image. In particular, the multi-task image editing system 106 receives the text prompt 204 as a natural language explanation of a target synthesized digital image (e.g., ants lifting a toy car). In one or more embodiments, the multi-task image editing system 106 utilizes the text prompt 204 to reference assets, backgrounds, or positioning from the reference digital image(s) 202 for inclusion in a target synthesized digital image. In additional embodiments, the multi-task image editing system 106 combines both a natural language description of a target synthesized digital image (e.g., a case prompt) and a selection from one or more predefined characteristics (e.g., a task prompt) to form the text prompt 204. FIG. 4 and the corresponding description provide additional detail related to a case prompt and a task prompt.

In some cases, a prompt includes a message or input used to request a response or action (e.g., generating a synthesized digital image). In particular, a prompt includes an instruction or a set of instructions input via a user interface directing one or more neural networks to perform an action. For example, a prompt includes a natural language description of a target synthesized digital image as well as selections from predetermined options guiding an image generation via an image generation neural network such as a diffusion neural network.

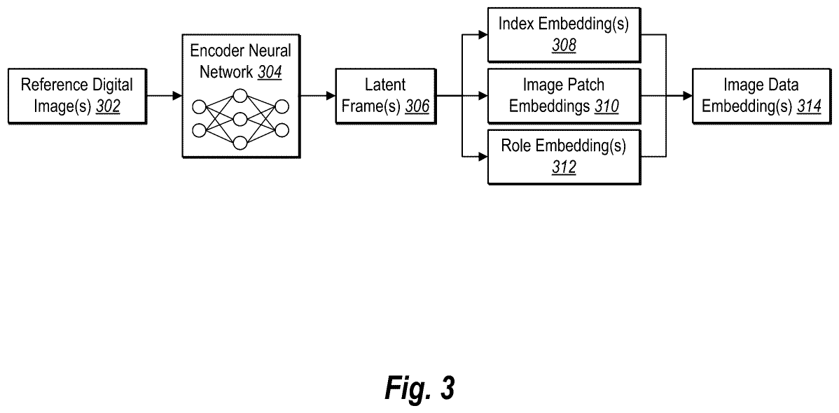

As further illustrated in FIG. 2, the multi-task image editing system 106 processes the reference digital image(s) 202 and the text prompt 204 through an encoder neural network 206. In particular, the multi-task image editing system 106 utilizes the encoder neural network 206 to encode representations of the reference digital image(s) 202 and the text prompt 204. In one or more embodiments, the multi-task image editing system 106 utilizes the encoder neural network 206 to generate one or more embeddings for the reference digital image(s) 202 representing an order of the reference digital image(s) 202, a role of the reference digital image(s) 202, and correlation of the reference digital image(s) 202 with the text prompt 204. Additionally, the multi-task image editing system 106 utilizes the encoder neural network 206 to generate an encoding of the text prompt 204. FIGS. 3-4 and the corresponding description provide additional detail related to encoding image and prompt data.

In some cases, an embedding refers to a representation of data in a different format or space. In particular, an embedding involves mapping high-dimensional data, such as words (e.g., the text prompt 204) or images (e.g., the reference digital image(s) 202), into a lower-dimensional vector space while preserving its meaning or relationships. For example, embeddings represent data in dense, fixed-length numerical vectors which capture semantic or structural relationships in text content and/or image content for later analyzing or processing. In various embodiments, one or more encoder neural networks generate text embeddings and image embeddings in separate feature spaces or in a shared feature space.

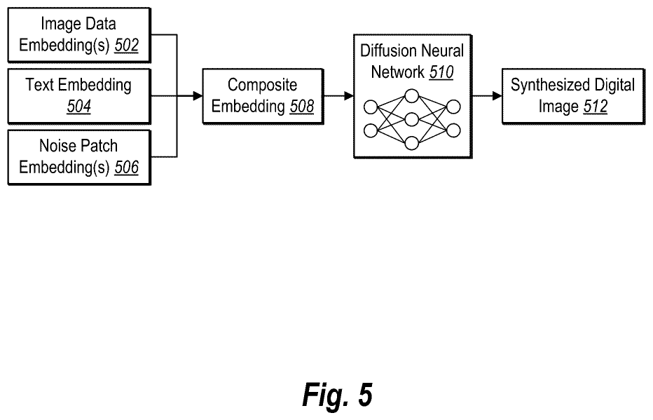

As further illustrated in FIG. 2, the multi-task image editing system 106 combines the embeddings and encodings generated by the encoder neural network 206 to form a composite embedding 208. In particular, the multi-task image editing system 106 utilizes the composite embedding 208 as a hierarchical prompt providing guidance on how to utilize the reference digital image(s) 202 and the text prompt 204 to generate the synthesized digital image 212. In one or more embodiments, the multi-task image editing system 106 generates the composite embedding 208 to indicate relationships between the reference digital image(s) 202 and the text prompt 204, leading to utilization of assets, backgrounds, and positioning of the reference digital image(s) 202 according to the text prompt 204. FIG. 5 and the corresponding description provide additional detail related to combining embeddings.

As further illustrated in FIG. 2, the multi-task image editing system 106 utilizes a diffusion neural network 210 to process the composite embedding 208 and generate a synthesized digital image 212 based on the composite embedding 208. In particular, the multi-task image editing system 106 generates the synthesized digital image 212 by prompting the diffusion neural network 210 with the composite embedding 208. As illustrated, the multi-task image editing system 106, by prompting the diffusion neural network 210 with the composite embedding 208, generates a synthesized digital image 212 that incorporates assets, backgrounds, and positioning of the reference digital image(s) 202 with the natural language description of the text prompt 204 (e.g., depicting ants lifting the toy car in the same position with the same snowy background). FIG. 5 and the corresponding description provide additional detail related to synthesizing image content from a composite embedding.

As mentioned, in one or more embodiments, the multi-task image editing system 106 utilizes an encoder neural network to generate embeddings for reference digital image(s) for guiding image synthesis. FIG. 3 illustrates a diagram depicting generating image data embeddings that include one or more types of embeddings representing a set of reference digital images and context information for the reference digital images.

As illustrated in FIG. 3, the multi-task image editing system 106 utilizes an encoder neural network 304 to process one or more reference digital image(s) 302, generating one or more latent frame(s) 306. In particular, the multi-task image editing system 106 utilizes the encoder neural network 304 to encode each image from the reference digital image(s) 302 as a latent frame to generate the latent frame(s) 306. In one or more embodiments, the multi-task image editing system 106 generates the latent frame(s) 306 by projecting the features of the reference digital image(s) 302 into latent space (e.g., by mapping high-dimensional image data into a lower-dimensional latent space).

In some cases, a latent frame includes a representation of an image in a compressed form within a latent space. In particular, a latent frame captures essential features and structures of an image. For example, a latent frame is a multidimensional array or vector in the latent space encoding complex patterns like textures, shapes, and styles of digital images.

As further illustrated in FIG. 3, the multi-task image editing system 106 generates one or more index embedding(s) 308 from the latent frame(s) 306. In particular, the multi-task image editing system 106 generates the index embedding(s) 308 to represent an order of the reference digital image(s) 302 correlating with an order that the reference digital image(s) 302 are mentioned in a natural language prompt (e.g., the text prompt 204). For example, the multi-task image editing system 106 generates the index embedding(s) 308 to specify that one of the reference digital image(s) 302 is the first image mentioned in a natural language prompt with the index embedding(s) 308 of “IMG1” and to specify that another of the reference digital image(s) 302 is the second image mentioned in a natural language prompt with the index embedding(s) 308 of “IMG2.”

As further illustrated in FIG. 3, the multi-task image editing system 106 generates image patch embeddings 310 from the latent frame(s) 306. In particular, the multi-task image editing system 106 generates the image patch embeddings 310 by dividing the latent frame(s) 306 into patches (e.g., based on the corresponding positions relative to the reference digital image(s) 302) and determines the image patch embeddings 310 from the patches of the latent frame(s) 306. Thus, the image patch embeddings 310 include embedding representations of patches of the reference digital image(s) 302 via the latent frame(s) 306.

In one or more embodiments, the multi-task image editing system 106 generates a set of embedding pairs associating tokens within the image patch embeddings 310 with portions of a natural language prompt (e.g., the text prompt). For example, the multi-task image editing system 106 generates the embedding pairs to link the image patch embeddings 310 to mentions of the reference digital image(s) 302 (e.g., a toy car) in the natural language prompt (e.g., a prompt specifying an image of “ants lifting the toy car”). For instance, the multi-task image embedding system 106 generates the embedding pairs using the index embedding(s) 308. Accordingly, an embedding pair links image patch embeddings for a particular reference digital image to a corresponding portion of the prompt, such as by generating metadata that stores the information for the embedding pair or by replacing a portion of the prompt with an identifier of the corresponding reference digital image.

As further illustrated in FIG. 3, the multi-task image editing system 106 generates one or more role embedding(s) 312 for the latent frame(s) 306. In particular, the multi-task image editing system 106 generates the role embedding(s) 312 to represent the role of the reference digital image(s) 302 in synthesizing a target synthesized digital image. For example, the multi-task image editing system 106 generates the role embedding(s) 312 to indicate whether the reference digital image(s) 302 serve as an asset image, a canvas image, or a control image. To illustrate, a role embedding indicating that a reference digital image is an asset image indicates that the reference digital image contains an asset (e.g., a specific object such as a toy car) to be included in the target synthesized digital image. A role embedding indicating that the reference digital image is a canvas image indicates that the background of the reference digital image (e.g., a snowy background) is to be included in the target synthesized digital image. A role embedding indicating that the reference digital image is a control image indicates a positioning for one or more assets in the target synthesized digital image, such as an indication to position a generated object in a particular region of the target synthesized digital image.

As further illustrated in FIG. 3, the multi-task image editing system 106 combines the index embedding(s) 308, the image patch embeddings 310, and the role embedding(s) 312 to generate the image data embedding(s) 314. In particular, the multi-task image editing system 106 generates the image data embedding(s) 314 to serve as an input for generating a target synthesized digital image utilizing an image generation neural network (e.g., a diffusion neural network). More information on utilizing the image data embedding(s) 314 is provided in relation to FIG. 5.

As mentioned, in one or more embodiments, the multi-task image editing system 106 generates a text embedding from a text prompt. FIG. 4 illustrates a diagram depicting generating a text embedding from a task prompt and a case prompt in accordance with one or more embodiments.

As illustrated in FIG. 4, the multi-task image editing system 106 determines a task prompt 402 in connection with synthesizing a digital image. In particular, the multi-task image editing system 106 determines the task prompt 402 in response to one or more selections of attributes for a target synthesized digital image selected by a client device (e.g., the client device 116). For example, the multi-task image editing system 106 presents to the client device a set of options for image attributes (e.g., realistic/unrealistic style, static/dynamic/novel scenario, with/without reference object) of a target synthesized digital image. In some embodiments, the multi-task image editing system 106 infers the task prompt 402 from the natural language description of a case prompt (e.g., the case prompt 404) through sentence or keyword analysis.

As further illustrated in FIG. 4, the multi-task image editing system 106 determines a case prompt 404 in connection with synthesizing a digital image. In particular, the case prompt 404 includes a natural language description of a target synthesized digital image (e.g., “a group of ants lifting up a toy car”). In one or more embodiments, the multi-task image editing system 106 receives the case prompt 404 as an input from the client device. In certain embodiments, the case prompt 404 includes references to one or more reference digital images (e.g., “a group of ants lifting up the toy car from image 1”).

As further illustrated in FIG. 4, the multi-task image editing system 106 utilizes an encoder neural network 406 to process the task prompt 402 and the case prompt 404 and generate a text embedding 408. In particular, the multi-task image editing system 106 utilizes the encoder neural network 406 to encode and combine the task prompt 402 and the case prompt 404 to generate the text embedding 408. More information on utilizing the text embedding 408 is provided in relation to FIG. 5.

As mentioned, in one or more embodiments, the multi-task image editing system 106 utilizes a diffusion neural network to process a composite embedding to generate a synthesized digital image. FIG. 5 illustrates a diagram of the multi-task image editing system 106 generating a composite embedding and utilizing a diffusion neural network to process the composite embedding to generate a synthesized digital image.

As illustrated in FIG. 5, the multi-task image editing system 106 generates one or more image data embedding(s) 502, a text embedding 504, and one or more noise patch embedding(s) 506. In particular, the multi-task image editing system 106 generates the image data embedding(s) 502 according to the process depicted in FIG. 3. Additionally, the multi-task image editing system 106 generates the text embedding 504 according to the process depicted in FIG. 4. Further, in one or more embodiments, the multi-task image editing system 106 generates the noise patch embedding(s) 506 to represent latent noise in the latent space for denoising according to one or more reference digital images.

In some cases, noise in the context of machine learning refers to random data added to or present in an image. In particular, noise is often employed by generative models (e.g., the diffusion neural network 510) to provide the randomness necessary to produce diverse outputs or simulate initial uncertainty in the image. For example, noise in a generative model is a random vector or matrix sampled from distributions, which the network transforms into coherent images by progressively adding meaningful features (e.g., in a plurality of denoising steps).

As further illustrated in FIG. 5, the multi-task image editing system 106 combines the image data embedding(s) 502, the text embedding 504, and the noise patch embedding(s) 506 to generate a composite embedding 508. In particular, the multi-task image editing system 106 generates the composite embedding 508 to represent the features of reference digital images (e.g., the reference digital image(s) 302 of FIG. 3) as well as the features of one or more text prompts (e.g., the task prompt 402 and the case prompt 404 of FIG. 4). Further, the multi-task image editing system 106 generates the composite embedding 508 to represent the relation of the reference digital images with the text prompts, incorporating relationships between the text prompts and the reference digital images (e.g., the case prompt instructing the generation of an image “incorporating the toy car of image 1”). In one or more embodiments, the multi-task image editing system 106 generates the composite embedding 508 by concatenating the image data embedding(s) 502, the text embedding 504, and the noise patch embedding(s) 506. In one or more embodiments, the multi-task image editing system 106 generates the composite embedding 508 as a one-dimensional tensor.

As further illustrated, the multi-task image editing system 106 utilizes a diffusion neural network 510 to process the composite embedding 508 to generate a synthesized digital image 512. In particular, the multi-task image editing system 106 prompts the diffusion neural network 510 with the composite embedding 508. In one or more embodiments, the multi-task image editing system 106 generates the synthesized digital image 512 to incorporate content from one or more portions of the reference digital images according to the description of the text prompt and the corresponding role(s) of the reference digital images (e.g., an asset, a background, or control of a position).

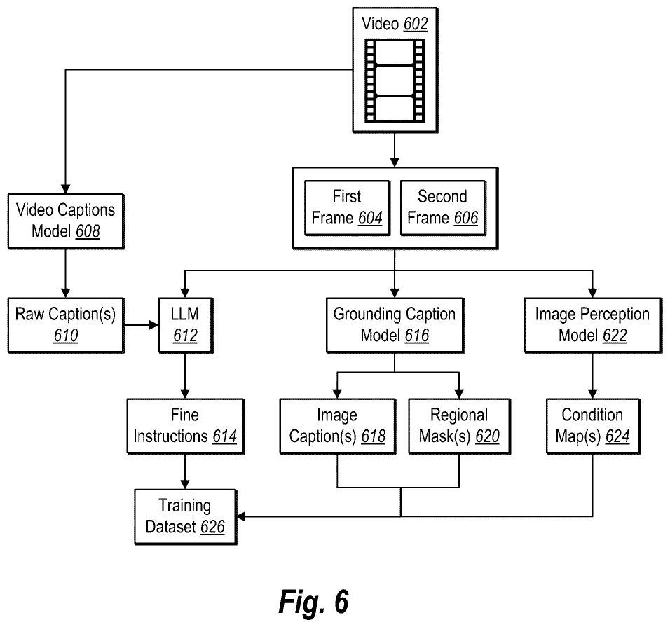

As mentioned, in one or more embodiments, the multi-task image editing system 106 generates a training dataset to train a diffusion neural network. FIG. 6 illustrates a sample diagram of the multi-task image editing system 106 generating a training dataset from frames of a video in accordance with one or more embodiments. Specifically, FIG. 6 illustrates generation of a training dataset including frames of a video and image captions for various use cases. In one or more embodiments, the training dataset includes data used to train a diffusion neural network to perform universal instructive image editing by generating digital images in accordance with natural language descriptions. Further, in certain embodiments, the training dataset includes data used to train the diffusion neural network to customize digital images, such as by adding objects, removing objects, or inpainting regions of a digital image.

As illustrated in FIG. 6, the multi-task image editing system 106 processes a video 602 to randomly select a first frame 604 and a second frame 606 as separate digital images. In particular, the multi-task image editing system 106 accesses the video 602 from a database (e.g., the database 114). In one or more embodiments, the multi-task image editing system 106 randomly selects the first frame 604 and the second frame 606 as two frames with a set interval from one another (e.g., with an interval of four seconds).

As further illustrated in FIG. 6, the multi-task image editing system 106 further utilizes a video captions model 608 to process the video 602 to generate raw caption(s) 610. In particular, the multi-task image editing system 106 generates the raw caption(s) 610 as video-level captions describing the video 602. In one or more embodiments, the multi-task image editing system 106 generates the raw caption(s) 610 as a natural language description of the video 602. In certain embodiments, the multi-task image editing system 106 generates the raw caption(s) 610 as a frame-by-frame natural language description of the video 602.

As further illustrated in FIG. 6, the multi-task image editing system 106 utilizes a large language model (“LLM 612”) to process the raw caption(s) 610 and the first frame 604 and the second frame 606 to generate fine instructions 614. In particular, the multi-task image editing system 106 prompts the LLM 612 with the raw caption(s) 610 and the first frame 604 and the second frame 606 and instructs the LLM 612 to generate fine instructions 614 describing how to transform the first frame 604 into the second frame 606. For example, if the first frame 604 depicted a mountain scene and the second frame 606 depicted a person swinging in front of the mountain scene, the multi-task image editing system 106 would utilize the LLM 612 to generate the fine instructions 614 to add a person swinging to the mountains of the first frame 604.

As further illustrated in FIG. 6, the multi-task image editing system 106 utilizes a grounding caption model 616 to process the first frame 604 and the second frame 606 to generate image caption(s) 618. In particular, the multi-task image editing system 106 utilizes the grounding caption model 616 to generate the image caption(s) 618 based off of bounding boxes of image elements in the first frame 604 and the second frame 606. For example, if the first frame 604 and the second frame 606 depict a boy and a girl jumping on a bed, the multi-task image editing system 106 utilizes the grounding caption model 616 to identify the boy, the girl, and the bed as image elements and generate the image caption(s) 618 describing “a boy and a girl jumping on a bed.”

As further illustrated in FIG. 6, the multi-task image editing system 106 additionally utilizes the grounding caption model 616 to generate regional mask(s) 620 for the first frame 604 and the second frame 606. In particular, the multi-task image editing system 106 generates the regional mask(s) 620 to isolate or highlight specific areas of the first frame 604 and the second frame 606. For example, if the first frame 604 and the second frame 606 depict a boy and a girl jumping on a bed, the multi-task image editing system 106 utilizes the grounding caption model 616 to generate the regional mask(s) 620 corresponding to the boy, the girl, and the bed.

In some cases, a regional mask in the context of image processing includes an image mask used to isolate or highlight specific areas of an image. In particular, a regional mask defines regions of interest by marking certain pixels as part of the region while leaving others excluded. For example, a regional mask includes a matrix based on dimensions of the image, with each value indicating whether the corresponding pixel belongs to the selected region. In various embodiments, a regional mask includes a binary mask or an alpha matte generated by the grounding caption model 616.

As further illustrated in FIG. 6, the multi-task image editing system 106 utilizes an image perception model 622 to process the first frame 604 and the second frame 606 to generate condition map(s) 624. In particular, the multi-task image editing system 106 generates the condition map(s) 624 to define the depth map and the edge map of the first frame 604 and the second frame 606, with the depth map representing the distance of objects in a scene from the viewpoint of the camera and the edge map representing the edges or boundaries of the image. For example, if the first frame 604 and the second frame 606 depict a boy and a girl jumping on a bed, the multi-task image editing system 106 generates the condition map(s) 624 to describe how far away the boy, the girl, and the bed are from the camera as well as the boundaries of objects in the image.

As further illustrated in FIG. 6, the multi-task image editing system 106 combines the fine instructions 614, the image caption(s) 618, the regional mask(s) 620, and the condition map(s) 624 to generate a training dataset 626. In certain embodiments, the multi-task image editing system 106 adds additional training data from open-source data sets to the training dataset 626. Further, the multi-task image editing system 106 generates the training dataset 626 by tagging training data within the training dataset 626 with metadata indicating whether the training data depicts a static or moving camera. Additionally, the multi-task image editing system 106 tags the training dataset 626 to indicate that the data contained within is generated in a synthetic style or in a realistic style, analogous to the selectable options in the task prompt (e.g., the task prompt 402). In some embodiments, the multi-task image editing system 106 tags whether training data in the training dataset 626 includes reference objects, masking, or depth maps.

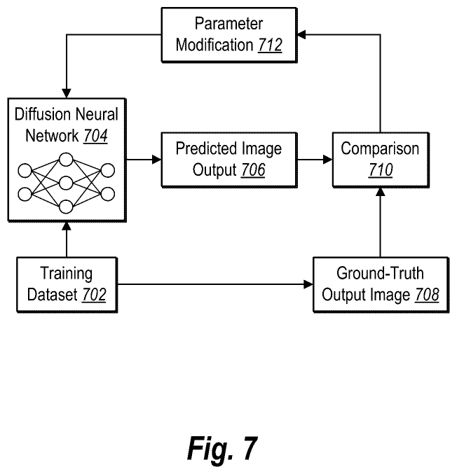

As mentioned, in one or more embodiments, the multi-task image editing system 106 trains a diffusion neural network to generate synthesized digital images from a training dataset. FIG. 7 illustrates a diagram of the multi-task image editing system 106 training the diffusion neural network to generate predicted output images in accordance with one or more embodiments.

As illustrated in FIG. 7, the multi-task image editing system 106 samples the training dataset 702, which includes pairs of images, captions/prompts, and ground-truth output images. In one or more embodiments, the multi-task image editing system 106 accesses the training dataset 702 from a dataset stored locally (e.g., on the server device(s) 102) or remotely (e.g., on the database or the client device). In one or more embodiments, the multi-task image editing system 106 accesses an input image and/or a text prompt (or caption) from the training dataset 702 for synthesizing a digital image.

As further illustrated in FIG. 7, the multi-task image editing system 106 utilizes a diffusion neural network 704 to generate a predicted output image 706 from the sampled text prompt and/or input image. In particular, the multi-task image editing system 106 utilizes the diffusion neural network 704 to generate the predicted output image 706 to represent a synthesized digital image as prompted by the training dataset 702 according to the sampled text prompt.

In some embodiments, the multi-task image editing system 106 utilizes a sampled image with a text prompt to generate a synthesized digital image based on the sampled image. Accordingly, in some embodiments, the sampled image includes a first frame of a training pair, and the text prompt includes a generated caption for instructions to modify the first frame to obtain a synthesized digital image. In one or more embodiments, the ground-truth output image 708 includes a second frame of the training pair. Alternatively, the text prompt includes natural language instructions to generate a synthesized digital image represented by the ground-truth output image 708 (e.g., from one or more frames of a training pair). For example, the multi-task image editing system 106 utilizes training pairs from the training dataset described in relation to FIG. 6 according to one or more specific image synthesis operations for the diffusion neural network 704.

As further illustrated in FIG. 7, the multi-task image editing system 106 performs a comparison 710 of the predicted output image 706 with the ground-truth output image 708. In one or more embodiments, the multi-task image editing system 106 performs the comparison 710 to determine differences between the predicted output image 706 and the ground-truth output image 708. In certain embodiments, the multi-task image editing system 106 performs the comparison 710 by calculating a loss value between the predicted output image 706 and the ground-truth output image 708 (e.g., utilizing a flow matching loss function).

As further illustrated in FIG. 7, the multi-task image editing system 106, based on the comparison 710, performs a parameter modification 712 to train the diffusion neural network 704. In particular, the multi-task image editing system 106 uses the parameter modification 712 to improve the ability of the diffusion neural network 704 to generate the predicted output image 706 to match the ground-truth output image 708 based on the training dataset 702.

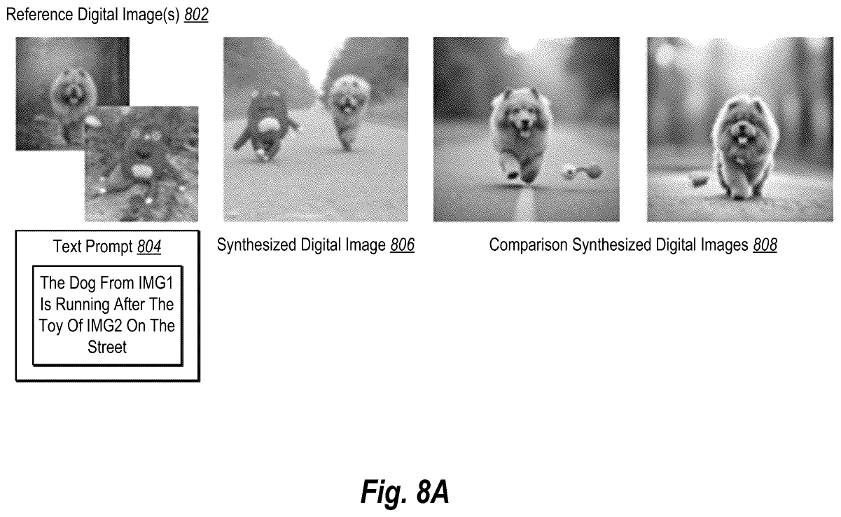

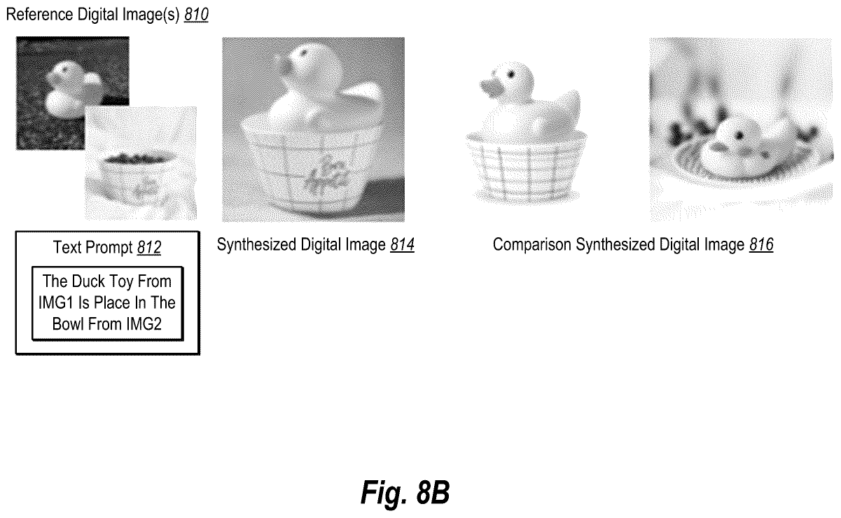

As mentioned, in one or more embodiments, the multi-task image editing system 106 generates synthesized digital images that integrate image elements from reference digital images while matching text prompts. FIGS. 8A-8B illustrate two example images of synthesized digital images integrating image elements from reference digital images in accordance with text prompts utilizing the multi-task image editing system 106 and conventional systems.

As illustrated in FIG. 8A, the multi-task image editing system 106 utilizes reference digital image(s) 802 and a text prompt 804 to synthesize a digital image as described in more detail above. In particular, the multi-task image editing system 106 receives reference digital image(s) 802 that include image elements (e.g., a dog and a toy), with the text prompt 804 referencing the image elements from the reference digital image(s) 802 (e.g., by requesting an image where “the dog from IMG1 is running after the toy of IMG2 on the street”). The multi-task image editing system 106 generates a composite embedding including image data embeddings and text embeddings for processing via a diffusion neural network.

As further illustrated in FIG. 8A, the multi-task image editing system 106 generates a synthesized digital image 806 that incorporates the image elements of the reference digital image(s) 802 according to the text prompt 804. As requested by the text prompt 804, the synthesized digital image 806 incorporates the dog from the first of the reference digital image(s) 802 and the toy from the second of the reference digital image(s) 802 in an image of the dog chasing after the toy. In contrast, the comparison synthesized digital images 808, which represent images generated by conventional systems, inaccurately depict the toy from the second of the reference digital image(s) 802.

FIG. 8B illustrates another example of reference digital image(s) 810 and a text prompt 812 for synthesizing a digital image. In particular, the multi-task image editing system 106 receives reference digital image(s) 810 that include image elements (e.g., a duck toy and a bowl), with the text prompt 812 referencing the image elements from the reference digital image(s) 810 (e.g., by requesting an image where “the duck toy from IMG1 is placed in the bowl from IMG2”). The multi-task image editing system 106 generates a composite embedding for processing via a diffusion neural network.

As further illustrated in FIG. 8B, the multi-task image editing system 106 generates a synthesized digital image 814 that incorporates the image elements of the reference digital image(s) 810 according to the text prompt 812. As requested by the text prompt 812, the synthesized digital image 814 incorporates the duck toy from the first of the reference digital image(s) 810 and the bowl from the second of the reference digital image(s) 810 in an image of the duck toy inside the bowl. In contrast, the comparison synthesized digital images 816, which represent images generated by conventional systems, inaccurately depict the duck toy from the first of the reference digital image(s) 810, the bowl from the second of the reference digital image(s) 810, or both.

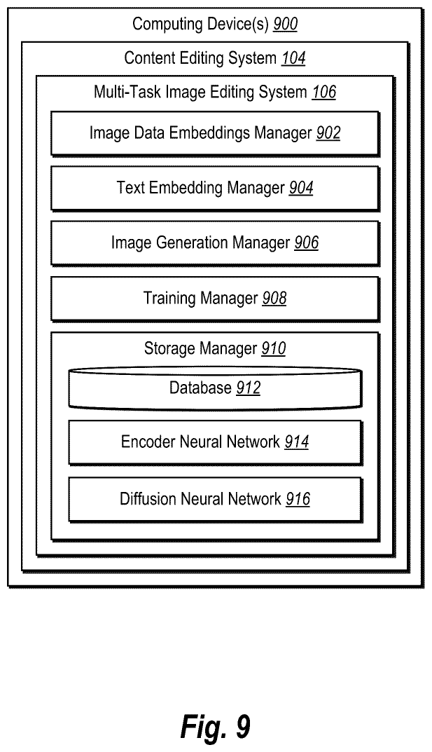

Referring now to FIG. 9, additional detail will be provided regarding components and capabilities of the multi-task image editing system 106. Specifically, FIG. 9 illustrates an example schematic diagram of the multi-task image editing system 106 on an example computing device(s) 900 (e.g., one or more of the client device 116 and/or the server device(s) 102). As shown in FIG. 9, the multi-task image editing system 106 includes an image data embeddings manager 902, a text embedding manager 904, an image generation manager 906, a training manager 908, and a storage manager 910.

As mentioned, the multi-task image editing system 106 includes an image data embeddings manager 902. In particular, the image data embeddings manager 902 generates, modifies, alters, or selects one or more image data embeddings (e.g., the image data embedding(s) 314 of FIG. 3). For example, the image data embeddings manager 902 generates image data embeddings representing roles for reference digital images, correlations between reference digital images and a text prompt, and an order for incorporating reference digital images.

As mentioned, the multi-task image editing system 106 includes a text embedding manager 904. In particular, the text embedding manager 904 generates, modifies, alters, or selects one or more text embeddings (e.g., the text embedding 408 of FIG. 4). For example, the text embedding manager 904 generates a text embedding representing a task prompt, a case prompt, or both.

As mentioned, the multi-task image editing system 106 includes an image generation manager 906. In particular, the image generation manager 906 generates, modifies, alters, or presents one or more synthesized images (e.g., the synthesized digital image 512 of FIG. 5). For example, the image generation manager 906 generates a synthesized digital image incorporating one or more reference digital images and based on a text prompt.

As mentioned, the multi-task image editing system 106 includes a training manager 908. In particular, the training manager 908 trains a diffusion neural network (e.g., the diffusion neural network 916) to generate synthesized digital images. For example, the training manager 908 accesses a training dataset and trains the diffusion neural network to predict an output digital image. In additional embodiments, the training manager 908 generates training data for training diffusion neural networks, such as by sampling frames from videos and generating captions/instructions corresponding to the sampled frames.

The multi-task image editing system 106 further includes a storage manager 910. The storage manager 910 operates in conjunction with the other components of the multi-task image editing system 106 and includes one or more memory devices such as the database 912 (e.g., the database 114) that stores various data such as reference digital images, text prompts, synthesized digital images, a training dataset, and other information. In some cases, the storage manager 910 also manages or maintains an encoder neural network 914 and a diffusion neural network 916 for generating synthesized digital images using one or more components of the multi-task image editing system 106 as described above.

In one or more embodiments, each of the components of the multi-task image editing system 106 are in communication with one another using any suitable communication technologies. Additionally, the components of the multi-task image editing system 106 are in communication with one or more other devices including one or more client devices described above. It will be recognized that although the components of the multi-task image editing system 106 are shown to be separate in FIG. 9, any of the subcomponents may be combined into fewer components, such as into a single component, or divided into more components as may serve a particular implementation. Furthermore, although the components of FIG. 9 are described in connection with the multi-task image editing system 106, at least some of the components for performing operations in conjunction with the multi-task image editing system 106 described herein may be implemented on other devices within the environment.

The components of the multi-task image editing system 106 include software, hardware, or both. For example, the components of the multi-task image editing system 106 include one or more instructions stored on a computer-readable storage medium and executable by processors of one or more computing devices (e.g., the computing device(s) 900). When executed by the one or more processors, the computer-executable instructions of the multi-task image editing system 106 cause the computing device(s) 900 to perform the methods described herein. Alternatively, the components of the multi-task image editing system 106 comprise hardware, such as a special purpose processing device to perform a certain function or group of functions. Additionally, or alternatively, the components of the multi-task image editing system 106 include a combination of computer-executable instructions and hardware.

Furthermore, the components of the multi-task image editing system 106 performing the functions described herein may, for example, be implemented as part of a stand-alone application, as a module of an application, as a plug-in for applications including content management applications, as a library function or functions that may be called by other applications, and/or as a cloud-computing model. Thus, the components of the multi-task image editing system 106 may be implemented as part of a stand-alone application on a personal computing device or a mobile device. Alternatively, or additionally, the components of the multi-task image editing system 106 may be implemented in any application that allows creation and delivery of content to users, including, but not limited to, ADOBE® applications such as ADOBE® ACROBAT®, ADOBE® PHOTOSHOP®, and ADOBE® FIREFLY®. “ADOBE,” “ACROBAT,” “PHOTOSHOP,” and “FIREFLY” are either registered trademarks or trademarks of Adobe Inc. in the United States and/or other countries.

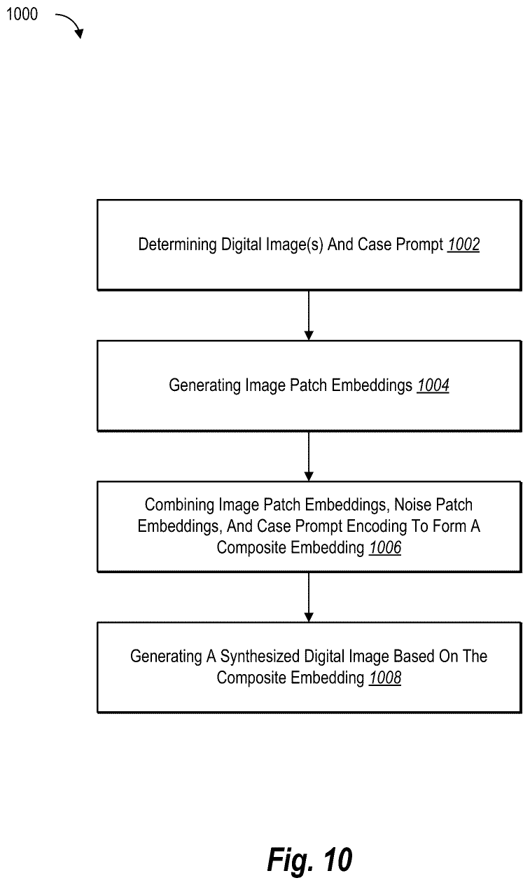

FIGS. 1-9, the corresponding text, and the examples provide a number of different systems, methods, and non-transitory computer readable media for generating a synthesized digital image from one or more reference digital images and a text prompt. In addition to the foregoing, embodiments can also be described in terms of flowcharts comprising acts for accomplishing a particular result. For example, FIG. 10 illustrates a flowchart of example sequences or series of acts in accordance with one or more embodiments.

While FIG. 10 illustrates acts according to particular embodiments, alternative embodiments may omit, add to, reorder, and/or modify any of the acts shown in FIG. 10. The acts of FIG. 10 can be performed as part of a method. Alternatively, a non-transitory computer readable medium can comprise instructions that, when executed by one or more processors, cause a computing device to perform the acts of FIG. 10. In still further embodiments, a system can perform the acts of FIG. 10. Additionally, the acts described herein may be repeated or performed in parallel with different instances of the same or other similar acts.

FIG. 10 illustrates an example series of acts 1000 for generating a modified digital design. In particular, the series of acts 1000 includes an act 1002 of determining digital image(s) and case prompt. For example, the act 1002 involves receiving one or more reference digital images and a case prompt comprising a natural language description of a target digital image. Further, the series of acts 1000 includes an act 1004 of generating image patch embeddings. For example, the act 1002 involves utilizing an encoder neural network to generate image patch embeddings from the one or more reference digital images with one or more role indicators for the one or more reference digital images and noise patch embeddings from latent noise. Further, the series of acts 1000 includes an act 1006 of combining image patch embeddings, noise patch embeddings, and case prompt encoding to form a composite embedding. For example, the act 1006 involves combining the image patch embeddings, noise patch embeddings, and a case prompt encoding of the case prompt to form a composite embedding. Further, the series of acts 1000 includes an act 1008 of generating a synthesized digital image based on the composite embedding. For example, the act 1008 involves utilizing a diffusion neural network to generate a synthesized digital image based on the composite embedding and one or more role indicators for the one or more reference digital images.

In some embodiments, the series of acts 1000 includes determining, in response to a selection from the client device, a task prompt comprising one or more predefined target digital image characteristics. The series of acts 1000 also includes combining the task prompt with the case prompt.

In some embodiments, the series of acts 1000 includes generating one or more latent frames corresponding to the one or more reference digital images. The series of acts 1000 also includes generating the image patch embeddings from the one or more latent frames. The series of acts 1000 also includes generating one or more index embeddings indicating an order for the one or more reference digital images. The series of acts 1000 also includes generating a set of embedding pairs associating the image patch embeddings with one or more referential words from the case prompt.

In some embodiments, the series of acts 1000 includes adding the one or more referential words as tokens for a prompt encoder neural network corresponding to the case prompt. The series of acts 1000 also includes assigning one or more index embeddings for the one or more referential words to corresponding image patch embeddings. The series of acts 1000 also includes assigning one or more roles for the one or more reference digital images. The series of acts 1000 also includes generating, utilizing the encoder neural network, the one or more role indicators by generating one or more role embeddings corresponding to the one or more roles.

In some embodiments, the series of acts 1000 includes determining that a reference digital image of the one or more reference digital images corresponds to an asset that provides one or more visual elements for the target digital image; a canvas that provides a background for the target digital image; or a control that indicates a positioning of the target digital image.

In some embodiments, the series of acts 1000 includes generating, utilizing a prompt encoder neural network, the case prompt encoding of the case prompt. The series of acts 1000 also includes generating the composite embedding by concatenating the image patch embeddings, the noise patch embeddings, and the case prompt encoding.

In some embodiments, the series of acts 1000 includes determining, in response to a request from a client device, a reference digital image and a case prompt comprising a natural language description of a target digital image. The series of acts 1000 also includes linking the reference digital image to a portion of the case prompt utilizing an index embedding. The series of acts 1000 also includes generating, utilizing a diffusion neural network and according to the index embedding, a composite embedding by combining image patch embeddings representing the reference digital image, noise patch embeddings representing latent noise, and a text embedding representing the case prompt. The series of acts 1000 also includes generating, utilizing the diffusion neural network, a synthesized digital image based on the composite embedding according to a role of the reference digital image.

In some embodiments, the series of acts 1000 includes determining, for the reference digital image, a role indicator by generating a role embedding corresponding to the role of the reference digital image. The series of acts 1000 also includes combining the role embedding and the image patch embeddings. The series of acts 1000 also includes determining, based on the request from the client device, a task prompt indicating one or more tasks from a set of predefined tasks for the case prompt. The series of acts 1000 also includes combining the task prompt with the case prompt to generate the text embedding.

In some embodiments, the series of acts 1000 includes encoding the reference digital image as a latent frame. The series of acts 1000 also includes separating the latent frame into a plurality of patches. The series of acts 1000 also includes generating the image patch embeddings representing the plurality of patches. The series of acts 1000 also includes generating a set of embedding pairs associating the image patch embeddings with a referential word from the case prompt. The series of acts 1000 also includes generating the index embedding indicating a frame order for the set of embedding pairs. The series of acts 1000 also includes combining the image patch embeddings, the noise patch embeddings, and the text embedding to form the composite embedding based on the index embedding.

In some embodiments, the series of acts 1000 includes determining, in response to a request from a client device, one or more reference digital images and a case prompt comprising a natural language description of a target digital image. The series of acts 1000 also includes generating, utilizing an encoder neural network, image patch embeddings from the one or more reference digital images with one or more role indicators for the one or more reference digital images and noise patch embeddings from latent noise. The series of acts 1000 also includes combining the image patch embeddings, the noise patch embeddings, and a case prompt encoding of the case prompt to form a composite embedding. The series of acts 1000 also includes generating, utilizing a diffusion neural network, a synthesized digital image based on the composite embedding and the one or more role indicators for the one or more reference digital images.

In some embodiments, the series of acts 1000 includes generating one or more latent frames corresponding to the one or more reference digital images. The series of acts 1000 also includes separating the one or more latent frames corresponding to the one or more reference digital images to generate one or more latent image patches. The series of acts 1000 also includes generating the image patch embeddings from the one or more latent image patches. The series of acts 1000 also includes generating a one-dimensional tensor by concatenating the image patch embeddings, the noise patch embeddings, and the case prompt encoding.

In some embodiments, the series of acts 1000 includes generating a training dataset for learning parameters of one or more neural networks comprising the diffusion neural network by: randomly selecting a first frame and a second frame from one or more digital videos in a dataset comprising a plurality of digital videos; generating one or more captions for the first frame and the second frame; and generating a training set comprising the first frame, the second frame, and the one or more captions. The series of acts 1000 also includes prompting a large language model to generate a natural language description of how to convert the first frame into the second frame. The series of acts 1000 also includes generating a bounding box enclosing one or more image elements corresponding to one or more nouns within the first frame and the second frame.

### Architecture: Pixel Diffusion

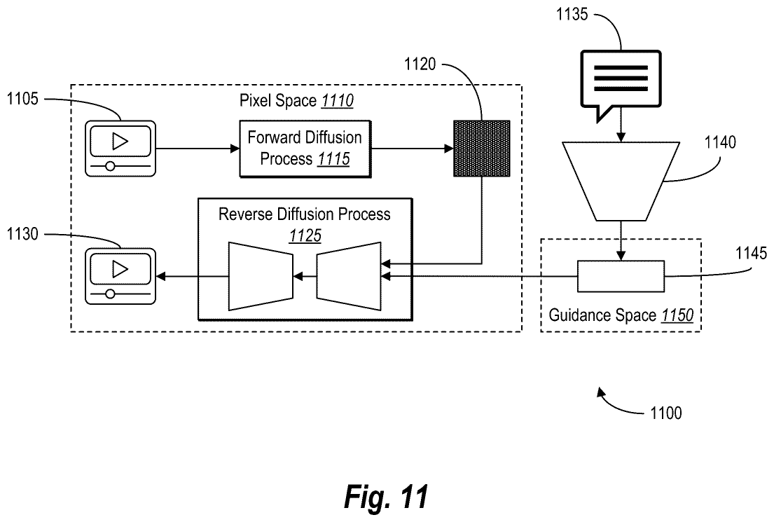

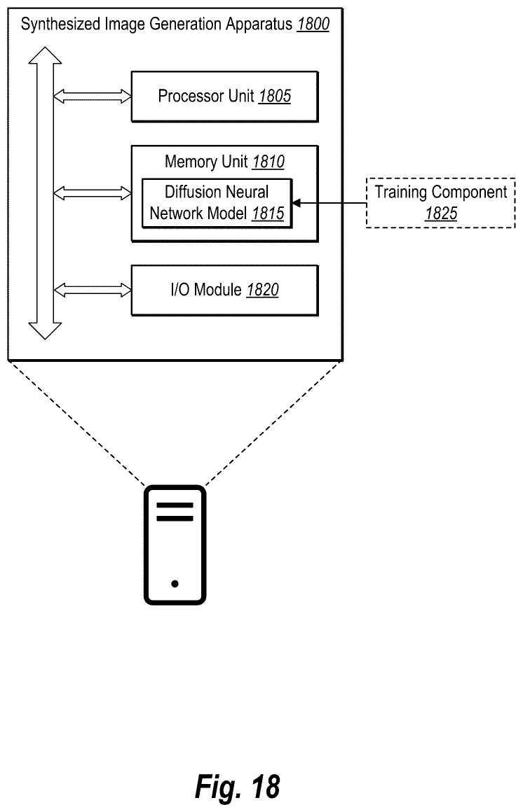

FIG. 11 shows an example of a guided diffusion model 1100 according to aspects of the present disclosure. In some examples, guided diffusion model 1100 describes the operation and architecture of the diffusion neural network model 1815 described with reference to FIG. 18. The guided diffusion model 1100 depicted in FIG. 11 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided diffusion model 1100 may take an original media item 1105 in a pixel space 1110 as input and apply forward diffusion process 1115 to gradually add noise to the original media item 1105 to obtain noisy media item 1120 at various noise levels.

Next, a reverse diffusion process 1125 (e.g., a U-Net) gradually removes the noise from the noisy media item 1120 at the various noise levels to obtain an output media item 1130. In some cases, an output media item 1130 is created from each of the various noise levels. The output media item 1130 can be compared to the original media item 1105 to train the reverse diffusion process 1125.

The reverse diffusion process 1125 can also be guided based on a text prompt 1135, or another guidance prompt, such as an image, a layout, a segmentation map, etc. The text prompt 1135 can be encoded using a text encoder 1140 (e.g., a multimodal encoder) to obtain guidance features 1145 in guidance space 1150. The guidance features 1145 can be combined with the noisy media item 1120 at one or more layers of the reverse diffusion process 1125 to ensure that the output media item 1130 includes content described by the text prompt 1135. For example, guidance features 1145 can be combined with the noisy features using a cross-attention block within the reverse diffusion process 1125.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

### Architecture: U-Net

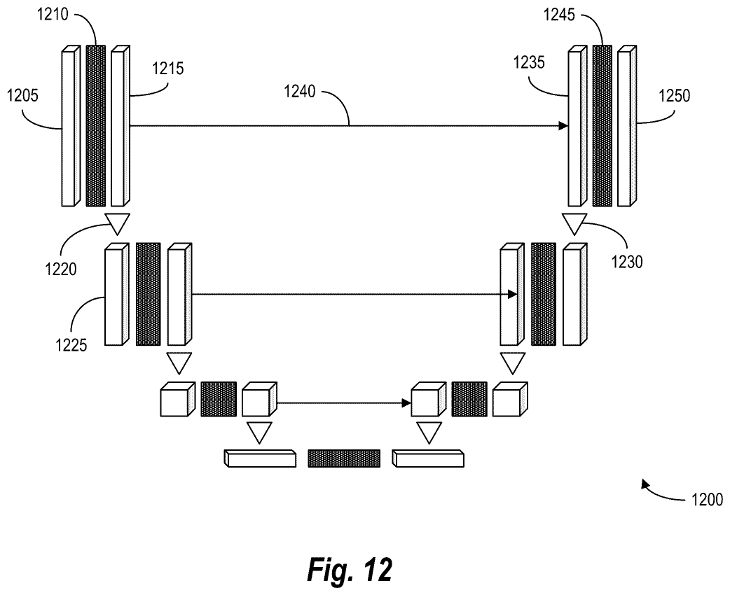

FIG. 12 shows an example of a U-Net 1200 according to aspects of the present disclosure. In some examples, U-Net 1200 is an example of the component that performs the reverse diffusion process 1125 of guided diffusion model 1100 described with reference to FIG. 11 and includes architectural elements of the diffusion neural network model 1815 described with reference to FIG. 18. The U-Net 1200 depicted in FIG. 12 is an example of, or includes aspects of, the architecture used within the reverse diffusion process described with reference to FIG. 11.

In some examples, diffusion models are based on a neural network architecture known as a U-Net. The U-Net 1200 takes input features 1205 having an initial resolution and an initial number of channels and processes the input features 1205 using an initial neural network layer 1210 (e.g., a convolutional network layer) to produce intermediate features 1215. The intermediate features 1215 are then down-sampled using a down-sampling layer 1220 such that down-sampled features 1225 features have a resolution less than the initial resolution and a number of channels greater than the initial number of channels.

This process is repeated multiple times, and then the process is reversed. That is, the down-sampled features 1225 are up-sampled using up-sampling process 1230 to obtain up-sampled features 1235. The up-sampled features 1235 can be combined with intermediate features 1215 having the same resolution and number of channels via a skip connection 1240. These inputs are processed using a final neural network layer 1245 to produce output features 1250. In some cases, the output features 1250 have the same resolution as the initial resolution and the same number of channels as the initial number of channels.

In some cases, U-Net 1200 takes additional input features to produce conditionally generated output. For example, the additional input features could include a vector representation of an input prompt. The additional input features can be combined with the intermediate features 1215 within the neural network at one or more layers. For example, a cross-attention module can be used to combine the additional input features and the intermediate features 1215.

### Inference: Conditional Generation

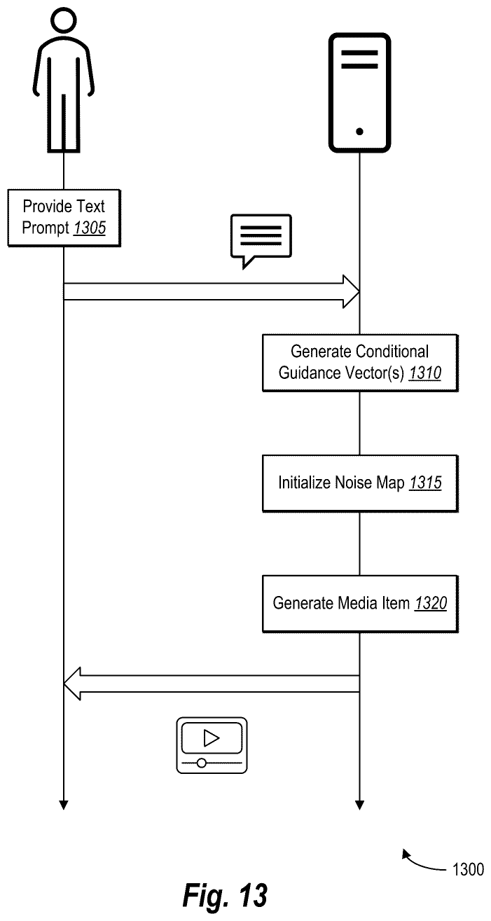

FIG. 13 shows an example of a method 1300 for conditional media generation according to aspects of the present disclosure. In some examples, method 1300 describes an operation of the diffusion neural network model 1815 described with reference to FIG. 18 such as an application of the guided diffusion model 1100 described with reference to FIG. 11. In some examples, these operations are performed by a system including a processor executing a set of codes to control functional elements of an apparatus such as the media generation model described in FIG. 11.

Additionally or alternatively, steps of the method 1300 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1305, a user provides a text prompt describing content to be included in a generated media item. For example, a user may provide the prompt “a person playing with a cat”. In some examples, guidance can be provided in a form other than text, such as via an image, a sketch, or a layout.

At operation 1310, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 1315, a noise map is initialized that includes random noise. The noise map may be in a pixel space or a latent space. By initializing a media item with random noise, different variations of a media item including the content described by the conditional guidance can be generated.

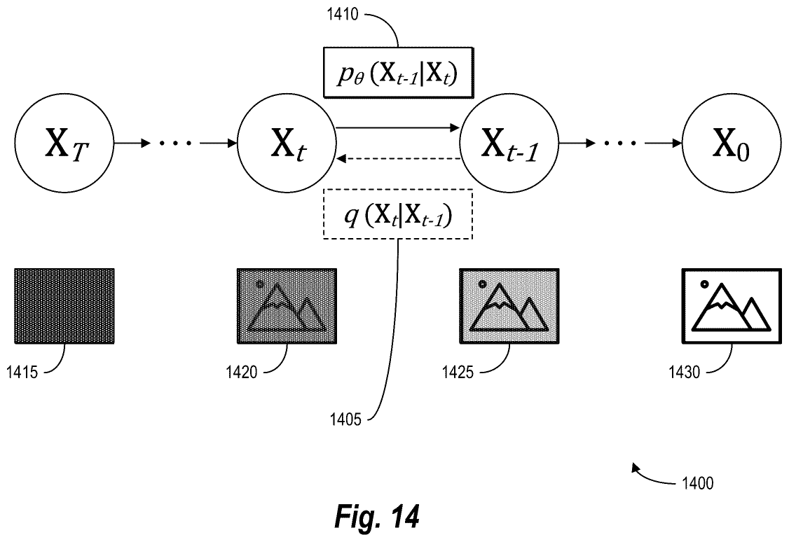

At operation 1320, the system generates a media item based on the noise map and the conditional guidance vector. For example, the media item may be generated using a reverse diffusion process as described with reference to FIG. 14.

### Inference: Reverse Diffusion

FIG. 14 shows a diffusion process 1400 according to aspects of the present disclosure. In some examples, diffusion process 1400 describes an operation of the diffusion neural network model 1815 described with reference to FIG. 18, such as the reverse diffusion process 1125 of guided diffusion model 1100 described with reference to FIG. 11.

As described above with reference to FIG. 11, using a diffusion model can involve both a forward diffusion process 1405 for adding noise to a media item (or features in a latent space) and a reverse diffusion process 1410 for denoising the media item (or features) to obtain a denoised media item. The forward diffusion process 1405 can be represented as q(xₜ|xₜ₋₁), and the reverse diffusion process 1410 can be represented as p(xₜ₋₁|xₜ). In some cases, the forward diffusion process 1405 is used during training to generate media items with successively greater noise, and a neural network is trained to perform the reverse diffusion process 1410 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1410, the model begins with noisy data x_{T}, such as a noisy media item 1415 and denoises the data to obtain the p(xₜ₋₁|xₜ). At each step t−1, the reverse diffusion process 1410 takes xₜ, such as first intermediate media item 1420, and t as input. Here, t represents a step in the sequence of transitions associated with different noise levels, The reverse diffusion process 1410 outputs xₜ₋₁, such as second intermediate media item 1425 iteratively until x_{T} reverts back to x₀, the original media item 1430. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N (x_{T}; 0, 1) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

### Training: Machine Learning

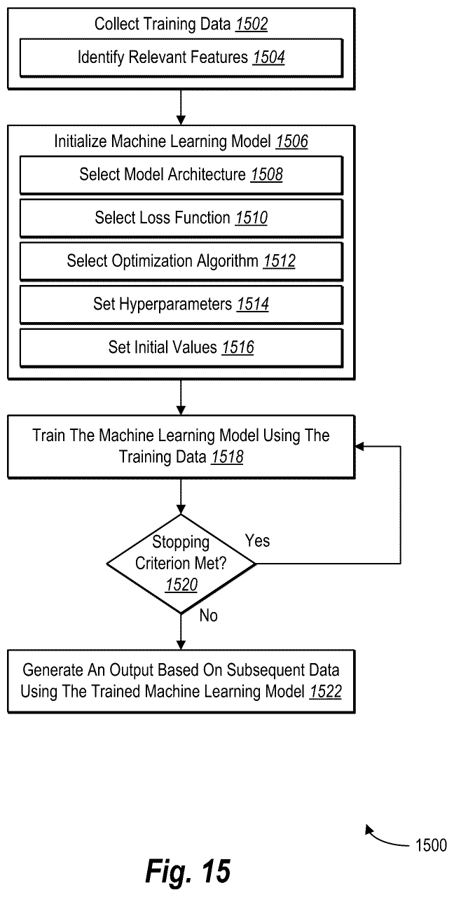

FIG. 15 is a flow diagram depicting an algorithm as a step-by-step procedure 1500 in an example implementation of operations performable for training a machine-learning model. In some embodiments, the step-by-step procedure 1500 describes an operation of the training component 1825 described for configuring the diffusion neural network model 1815 as described with reference to FIG. 18. The step-by-step procedure 1500 provides one or more examples of generating training data, use of the training data to train a machine-learning model, and use of the trained machine-learning model to perform a task.

To begin in this example, a machine-learning system collects training data (block 1502) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1504) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1506). Initialization of the machine-learning model includes selecting a model architecture (block 1508) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1510). The loss function is utilized to measure a difference between an output of the machine-learning model (i.e., predictions) and target values (e.g., as expressed by the training data) to be used to train the machine-learning model. Additionally, an optimization algorithm is selected (1512) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1516) examples of which includes initializing weights and biases of nodes to improve efficiency in training and computational resources consumption as part of training. Hyperparameters are also set (block 1514) that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1518) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1520), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1520), the step-by-step procedure 1500 continues training of the machine-learning model using the training data (block 1518) in this example.

If the stopping criterion is met (“yes” from decision block 1520), the trained machine-learning model is then utilized to generate an output based on subsequent data (block 1522). The trained machine-learning model, for instance, is trained to perform a task as described above and therefore once trained is configured to perform that task based on subsequent data received as an input and processed by the machine-learning model.

### Training: Diffusion Training

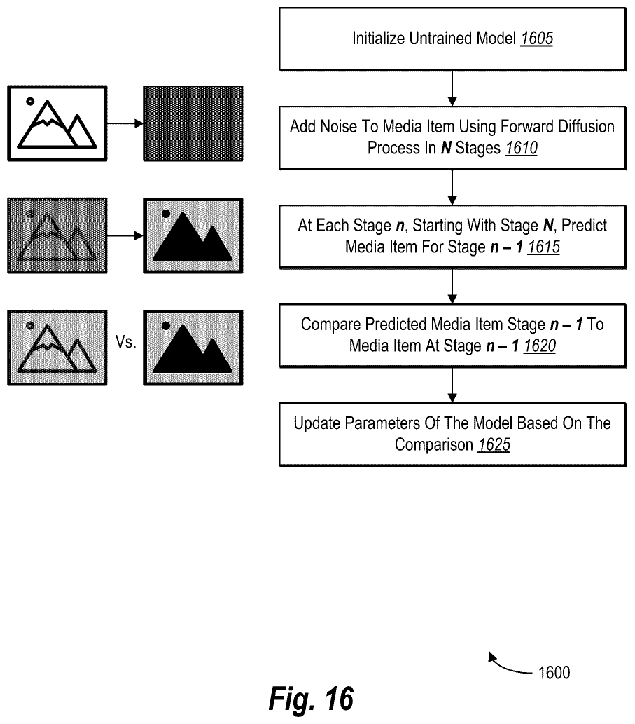

FIG. 16 shows an example of a method 1600 for training a diffusion model according to aspects of the present disclosure. In some embodiments, the method 1600 describes an operation of the training component 1825 described for configuring the diffusion neural network model 1815 as described with reference to FIG. 18. The method 1600 represents an example for training a reverse diffusion process as described above with reference to FIG. 14. In some examples, these operations are performed by a system including a processor executing a set of codes to control functional elements of an apparatus, such as the guided diffusion model described in FIG. 11.

Additionally or alternatively, certain processes of method 1600 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1605, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1610, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 1615, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1620, the system compares predicted output (or features) at stage n−1 to an actual media item (or features), such as the output at stage n−1 or the original input. For example, given observed data x, the diffusion model may be trained to minimize the variational upper bound of the negative log-likelihood-log pe (x) of the training data.

At operation 1625, the system updates parameters of the model based on the comparison. For example, parameters of a U-Net may be updated using gradient descent. Time-dependent parameters of the Gaussian transitions can also be learned.

### System: Computing Device

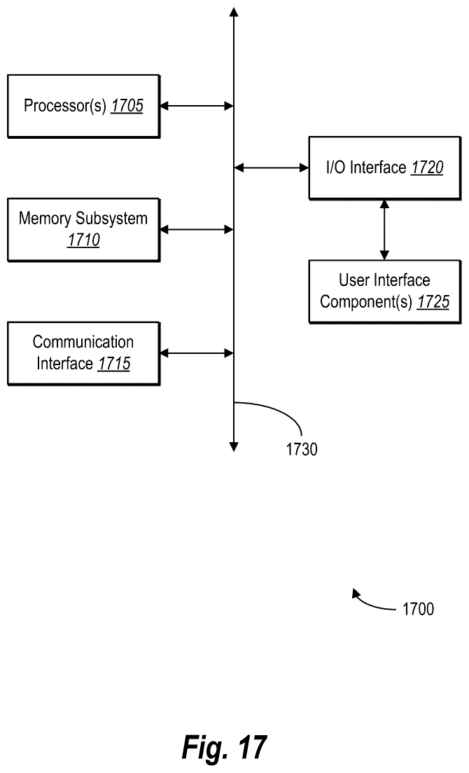

FIG. 17 shows an example of a computing device 1700 according to aspects of the present disclosure. The computing device 1700 may be an example of the synthesized image generation apparatus 1800 described with reference to FIG. 18. In one aspect, computing device 1700 includes one or more processors 1705, memory subsystem 1710, communication interface 1715, I/O interface 1720, user interface component(s) 1725, and channel 1730.

In some embodiments, computing device 1700 is an example of, or includes aspects of, the media generation model of FIG. 11. In some embodiments, computing device 1700 includes one or more processors 1705 that can execute instructions stored in memory subsystem 1710 to perform media generation.

According to some aspects, computing device 1700 includes one or more processors 1705. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1710 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1715 operates at a boundary between communicating entities (such as computing device 1700, one or more user devices, a cloud, and one or more databases) and channel 1730 and can record and process communications. In some cases, communication interface 1715 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1720 is controlled by an I/O controller to manage input and output signals for computing device 1700. In some cases, I/O interface 1720 manages peripherals not integrated into computing device 1700. In some cases, I/O interface 1720 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1720 or via hardware components controlled by the I/O controller.

According to some aspects, user interface component(s) 1725 enable a user to interact with computing device 1700. In some cases, user interface component(s) 1725 include an audio device, such as an external speaker system, an external display device such as a display screen, an input device (e.g., a remote-control device interfaced with a user interface directly or through the I/O controller), or a combination thereof. In some cases, user interface component(s) 1725 include a GUI.

### System: Synthesized Image Generation Apparatus

FIG. 18 shows an example of a synthesized image generation apparatus 1800 according to aspects of the present disclosure. Synthesized image generation apparatus 1800 may include an example of, or aspects of, the guided diffusion model described with reference to FIG. 11 and the U-Net described with reference to FIG. 12. In some embodiments, synthesized image generation apparatus 1800 includes processor unit 1805, memory unit 1810, diffusion neural network model 1815, I/O module 1820, and training component 1825. Training component 1825 updates parameters of the diffusion neural network model 1815 stored in memory unit 1810. In some examples, the training component 1825 is located outside the synthesized image generation apparatus 1800.

Processor unit 1805 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1805 is configured to operate a memory array using a memory controller. In other cases, a memory controller is integrated into processor unit 1805. In some cases, processor unit 1805 is configured to execute computer-readable instructions stored in memory unit 1810 to perform various functions. In some aspects, processor unit 1805 includes special purpose components for modem processing, baseband processing, digital signal processing, or transmission processing. According to some aspects, processor unit 1805 comprises one or more processors described with reference to FIG. 17.

Memory unit 1810 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1805 to perform various functions described herein.

In some cases, memory unit 1810 includes a basic input/output system (BIOS) that controls basic hardware or software operations, such as an interaction with peripheral components or devices. In some cases, memory unit 1810 includes a memory controller that operates memory cells of memory unit 1810. For example, the memory controller may include a row decoder, column decoder, or both. In some cases, memory cells within memory unit 1810 store information in the form of a logical state. According to some aspects, memory unit 1810 is an example of the memory subsystem 1710 described with reference to FIG. 17.

According to some aspects, synthesized image generation apparatus 1800 uses one or more processors of processor unit 1805 to execute instructions stored in memory unit 1810 to perform functions described herein. For example, the synthesized image generation apparatus 1800 may generate synthesized digital images based on one or more reference digital images and a text prompt.

The memory unit 1810 may include a diffusion neural network model 1815 trained to generate synthesized digital images based on a composite embedding. For example, after training, the diffusion neural network model 1815 may perform inferencing operations as described with reference to FIGS. 13 and 14 to generate synthesized digital images based on a composite embedding.

In some embodiments, the diffusion neural network model 1815 is an Artificial neural network (ANN) such as the guided diffusion model described with reference to FIG. 11 and the U-Net described with reference to FIG. 12. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of diffusion neural network model 1815 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1825 may train the diffusion neural network model 1815. For example, parameters of the diffusion neural network model 1815 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 15 and 16). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the diffusion neural network model 1815 can be used to make predictions on new, unseen data (i.e., during inference).

I/O module 1820 receives inputs from and transmits outputs of the synthesized image generation apparatus 1800 to other devices or users. For example, I/O module 1820 receives inputs for the diffusion neural network model 1815 and transmits outputs of the diffusion neural network model 1815. According to some aspects, I/O module 1820 is an example of the I/O interface 1720 described with reference to FIG. 17.

What is claimed is:

1. A computer-implemented method comprising:
determining, in response to a request from a client device, one or more reference digital images and a case prompt comprising a natural language description of a target digital image;
generating, utilizing an encoder neural network, image patch embeddings from the one or more reference digital images with one or more role indicators for the one or more reference digital images and noise patch embeddings from latent noise;
combining the image patch embeddings, the noise patch embeddings, and a case prompt encoding of the case prompt to form a composite embedding; and
generating, utilizing a diffusion neural network, a synthesized digital image based on the composite embedding and the one or more role indicators for the one or more reference digital images.

2. The computer-implemented method of claim 1, further comprising forming the composite embedding by:
determining, in response to a selection from the client device, a task prompt comprising one or more predefined target digital image characteristics; and
combining the task prompt with the case prompt.

3. The computer-implemented method of claim 1, wherein generating the image patch embeddings comprises:
generating one or more latent frames corresponding to the one or more reference digital images; and
generating the image patch embeddings from the one or more latent frames.

4. The computer-implemented method of claim 1, wherein generating the image patch embeddings further comprises generating one or more index embeddings indicating an order for the one or more reference digital images.

5. The computer-implemented method of claim 1, wherein generating the image patch embeddings further comprises generating a set of embedding pairs associating the image patch embeddings with one or more referential words from the case prompt.

6. The computer-implemented method of claim 5, wherein generating the set of embedding pairs comprises:
adding the one or more referential words as tokens for a prompt encoder neural network corresponding to the case prompt; and
assigning one or more index embeddings for the one or more referential words to corresponding image patch embeddings.

7. The computer-implemented method of claim 1, wherein generating the image patch embeddings comprises:
assigning one or more roles for the one or more reference digital images; and
generating, utilizing the encoder neural network, the one or more role indicators by generating one or more role embeddings corresponding to the one or more roles.

8. The computer-implemented method of claim 7, wherein assigning the one or more roles comprises determining that a reference digital image of the one or more reference digital images corresponds to:
an asset that provides one or more visual elements for the target digital image;
a canvas that provides a background for the target digital image; or
a control that indicates a positioning of the target digital image.

9. The computer-implemented method of claim 1, wherein combining the image patch embeddings, the noise patch embeddings, and the case prompt encoding further comprises:
generating, utilizing a prompt encoder neural network, the case prompt encoding of the case prompt; and
generating the composite embedding by concatenating the image patch embeddings, the noise patch embeddings, and the case prompt encoding.

10. A system comprising:
one or more memory devices; and
one or more processors coupled to the one or more memory devices that cause the system to perform operations comprising:
determining, in response to a request from a client device, a reference digital image and a case prompt comprising a natural language description of a target digital image;
linking the reference digital image to a portion of the case prompt utilizing an index embedding;
generating, utilizing a diffusion neural network and according to the index embedding, a composite embedding by combining image patch embeddings representing the reference digital image, noise patch embeddings representing latent noise, and a text embedding representing the case prompt; and
generating, utilizing the diffusion neural network, a synthesized digital image based on the composite embedding according to a role of the reference digital image.

11. The system of claim 10, wherein the one or more processors are configured to perform a process further comprising:
determining, for the reference digital image, a role indicator by generating a role embedding corresponding to the role of the reference digital image; and
combining the role embedding and the image patch embeddings.

12. The system of claim 10, wherein the one or more processors are configured to determine the case prompt by:
determining, based on the request from the client device, a task prompt indicating one or more tasks from a set of predefined tasks for the case prompt; and
combining the task prompt with the case prompt to generate the text embedding.

13. The system of claim 10, wherein the one or more processors are configured to generate the composite embedding by:
encoding the reference digital image as a latent frame;
separating the latent frame into a plurality of patches; and
generating the image patch embeddings representing the plurality of patches.

14. The system of claim 10, wherein the one or more processors are configured to generate the composite embedding by:
generating a set of embedding pairs associating the image patch embeddings with a referential word from the case prompt;
generating the index embedding indicating a frame order for the set of embedding pairs; and
combining the image patch embeddings, the noise patch embeddings, and the text embedding to form the composite embedding based on the index embedding.

15. A non-transitory computer readable medium comprising instructions that, when executed by at least one processor, cause a computing device to perform operations comprising:
determining, in response to a request from a client device, one or more reference digital images and a case prompt comprising a natural language description of a target digital image;
generating, utilizing an encoder neural network, image patch embeddings from the one or more reference digital images with one or more role indicators for the one or more reference digital images and noise patch embeddings from latent noise;
combining the image patch embeddings, the noise patch embeddings, and a case prompt encoding of the case prompt to form a composite embedding; and
generating, utilizing a diffusion neural network, a synthesized digital image based on the composite embedding and the one or more role indicators for the one or more reference digital images.

16. The non-transitory computer readable medium of claim 15, wherein generating image patch embeddings from the one or more reference digital images comprises:
generating one or more latent frames corresponding to the one or more reference digital images;
separating the one or more latent frames corresponding to the one or more reference digital images to generate one or more latent image patches; and
generating the image patch embeddings from the one or more latent image patches.

17. The non-transitory computer readable medium of claim 15, wherein combining the image patch embeddings, the noise patch embeddings, and a case prompt encoding comprises generating a one-dimensional tensor by concatenating the image patch embeddings, the noise patch embeddings, and the case prompt encoding.

18. The non-transitory computer readable medium of claim 15, further comprising generating a training dataset for learning parameters of one or more neural networks comprising the diffusion neural network by:
randomly selecting a first frame and a second frame from one or more digital videos in a dataset comprising a plurality of digital videos;
generating one or more captions for the first frame and the second frame; and
generating a training set comprising the first frame, the second frame, and the one or more captions.

19. The non-transitory computer readable medium of claim 18, wherein generating the one or more captions for the one or more digital videos comprises prompting a large language model to generate a natural language description of how to convert the first frame into the second frame.

20. The non-transitory computer readable medium of claim 18, wherein generating the one or more captions further comprises generating a bounding box enclosing one or more image elements corresponding to one or more nouns within the first frame and the second frame.
